(19) United States
(12) Patent Application Publication
(10) Pub. No.: US 2005/0057401 A1
(43) Pub. Date: Mar. 17, 2005

(54) Small-size, low-height antenna device capable of easily ensuring predetermined bandwidth

(75) Inventor: Dou Yuanzhu, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/926,230

(22) Filed: Aug. 25, 2004

(30) Foreign Application Priority Data
Sep. 1, 2003 (JP) 2003-308714

(51) Int. Cl. H01Q 1/38; H01Q 1/24

(52) U.S. Cl. 343/700 MS; 343/702

(57) ABSTRACT

The antenna device 11 contain a first radiating conductive plate 13 arranged above a grounding conductor 12 so as to be substantially parallel and opposite to the grounding conductor 12; a second radiating conductive plate 14 adjacent to the first radiating conductive plate 13 with a slit 15 interposed therebetween; a feeding conductive plate 16 and a first shorting conductive plate 17 that extends substantially orthogonally from an outer edge of the first radiating conductive plate 13 so as not to be opposite to the slit 15; and a second shorting conductive plate 18 that extends substantially orthogonally from an outer edge of the second radiating conductive plate 14 so as not to be opposite to the slit 15. The feeding conductive plate 16 is connected to a feeding circuit, and the first and second shorting conductive plates 17 and 18 are connected to the grounding conductor 12.

### BACKGROUND OF THE INVENTION

1. Field of the Invention

The present invention relates to a small-size, low-height antenna device that is suitably used for an automobile antenna or a portable antenna, and more specifically to an inverted F-type antenna device composed of a sheet metal. 2. Description of the Related Art Conventionally, as an antenna device which can be easily implemented as a small-size, low-height antenna device compared to a monopole antenna or the like, an inverted F-type antenna device shown in FIG. 5 has been suggested (for example, refer to Japanese Unexamined Patent Application Publication No. 11-41026 (page 2, FIG. 5). As shown in FIG. 5, the inverted F-type antenna 1 is formed by bending a conductive metal plate and is fixed on a grounding conductor 2. The inverted F-type antenna 1 comprises a radiating conductive plate 3 arranged above the grounding conductor 2 so as to be substantially parallel and opposite to the grounding conductor 2, a feeding conductive plate 4 that extends substantially orthogonally from an outer edge of the radiating conductive plate 3 and whose lower end is connected to a feeding circuit (not shown), and a shorting conductive plate 5 that extends substantially orthogonally from the outer edge of the radiating conductive plate 3 and whose lower end is connected to the grounding conductor 2. A predetermined high frequency power is supplied to the feeding conductive plate 4 to resonate the radiating conductive plate 3. In this type of inverted F-type antenna 1, by suitably selecting a position of forming the shorting conductive plate 5, impedance mismatching can be easily avoided. As a result, there is an advantage in that the height of the entire antenna is easily reduced. In addition, since the inverted F-type antenna 1 is composed of a sheet metal easily formed by bending a conductive metal plate such as a copper plate, it is also advantageous in terms of manufacturing cost.

In addition, as another conventional example, an inverted F-type antenna has also been suggested, in which a crank-shaped notch is provided in a radiating conductive plate 3, an electric field of the radiating conductive plate 3 is enhanced, and in which the size of the antenna is even smaller.

However, in automobile antenna devices or in portable antenna devices, since antenna devices are required to be made smaller in size and height at a low cost, the inverted F-type antenna device has been of interest. Generally, the antenna device has a characteristic that by making the antenna device smaller and shorter in size, a bandwidth capable of being resonated becomes narrower. As a result, when making the above-mentioned conventional inverted F-type antenna smaller and shorter in size, it is difficult to ensure a predetermined bandwidth. Here, the bandwidth is in the frequency range in which a return loss (reflection attenuation quantity) is not more than −10 dB. But, the antenna device must ensure a bandwidth wider than the bandwidth of a use frequency. For this reason, making the antenna smaller and shorter in size becomes a difficult process.

### SUMMARY OF THE INVENTION

Accordingly, the present invention is made to solve the above-mentioned problems, and it is an object of the present invention to provide an inverted F-type antenna device capable of easily ensuring a predetermined bandwidth even when the antenna device is made smaller and shorter in size.

In order to achieve the above-mentioned object, the present invention provides an antenna device which comprises a first radiating conductive plate arranged above a grounding conductor so as to be substantially parallel and opposite to the grounding conductor; a second radiating conductive plate arranged above the grounding conductor so as to be substantially parallel and opposite to the grounding conductor and adjacent to the first radiating conductive plate with a slit interposed therebetween; a feeding conductive plate that extends substantially orthogonally from an outer edge of the first radiating conductive plate which so as not to be opposite to the slit and is connected to a feeding circuit; a first shorting conductive plate that extends substantially orthogonally from an outer edge of the first radiating conductive plate so as not to be opposite to the slit and is connected to the grounding conductor; and a second shorting conductive plate that extends substantially orthogonally from an outer edge of the second radiating conductive plate so as not to be opposite to the slit and is connected to the grounding conductor. Here, the first radiating conductive plate and the second radiating conductive plate are arranged to be adjacent to each other with a substantially line-symmetrical relationship using the slit as an axis of symmetry and are electromagnetically coupled with each other.

In the inverted F-type antenna device having the above-mentioned configuration, when a power is supplied to the feeding conductive plate to resonate the first radiating conductive plate, an induced current flows through the second radiating conductive plate by an electromagnetic coupling between the first radiating conductive plate and the second radiating conductive plate. As a result, it is possible to operate the second radiating conductive plate as a radiating element of a parasitic antenna. Thus, in the antenna device, two resonance points can be set, and the frequency difference between the two resonance points can be increased or decreased by suitably adjusting the electromagnetic coupling intensity between the first and second radiating conductive plates variable according to a width or length of the slit. Therefore, even when the antenna device is made smaller and shorter in size, it is possible to easily ensure a predetermined bandwidth by widening the frequency range in which a return loss is not more than a predetermined value.

In the antenna device having the above-mentioned configuration, in order to enhance an electric field, the notches are provided in the first and second radiating conductive plates, such that the size of the antenna may be still smaller. In this case, it is preferable that the notches of the first and second radiating conductive plates be formed to be substantially line-symmetric to each other using the slit as an axis of symmetry.

According to the inverted F-type antenna device of the present invention, by providing the second radiating conductive plate electromagnetically coupled with the first radiating conductive plate in the vicinity of the first radiating conductive plate to which a power is directly supplied through the feeding conductive plate, and by operating the second radiating conductive plate as the radiating element of the parasitic antenna, two resonance points are generated. Since the frequency difference between the two resonance points can be increased or decreased by suitably adjusting the electromagnetic coupling intensity between the first and second radiating conductive plates, it is possible to easily ensure a predetermined bandwidth even when the antenna device is made smaller and shorter in size. Thus, an antenna device, which is smaller and shorter in size, which is composed of a sheet metal, and which has a sufficient bandwidth, can be obtained at a low cost.

### BRIEF DESCRIPTION OF THE DRAWINGS

FIG. 1 is a perspective view showing an antenna device according to a first embodiment of the present invention;

FIG. 2 is a side view showing the antenna device according to the first embodiment of the present invention;

FIG. 3 is a characteristic view showing a return loss of the antenna device according to the first embodiment of the present invention;

FIG. 4 is a perspective view showing an antenna device according to a second embodiment of the present invention; and

FIG. 5 is a perspective view showing an inverted F-type antenna according to a conventional art.

### DESCRIPTION OF THE PREFERRED EMBODIMENTS

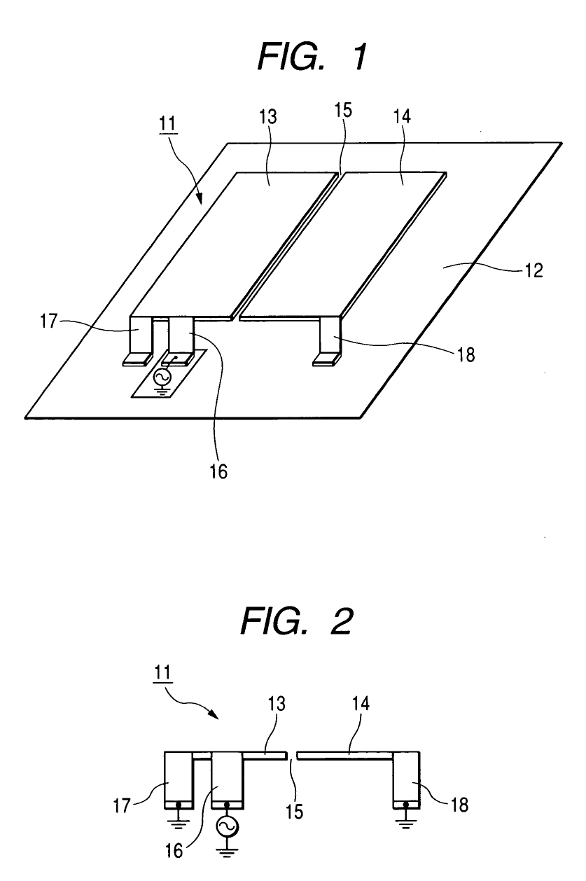

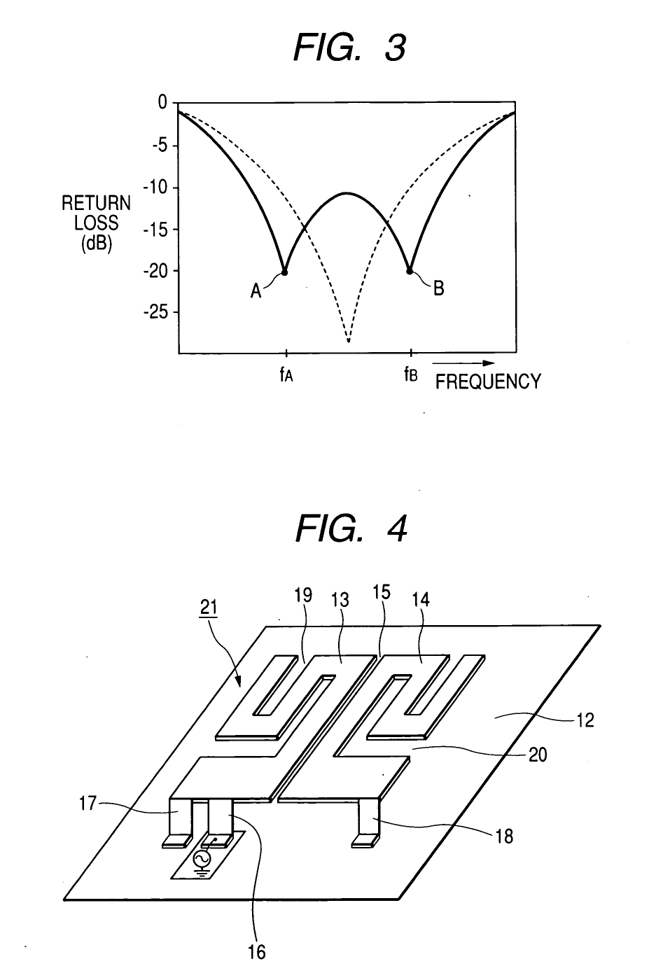

Embodiments of the present invention will now be described with reference to the accompanying drawings. FIG. 1 is a perspective view showing an antenna device according to a first embodiment of the present invention; FIG. 2 is a side view showing the antenna device according to the first embodiment of the present invention; and FIG. 3 is a characteristic view showing a return loss in accordance with a frequency of the antenna device according to the first embodiment of the present invention.

As shown in FIGS. 1 and 2, an antenna device 11 is composed of a sheet metal formed by bending a conductive metal plate such as a copper plate, and is fixed on a grounding conductor 12. The antenna device 11 comprises a first radiating conductive plate 13 and a second radiating conductive plate 14 arranged above the grounding conductor 12 so as to be substantially parallel and opposite to the grounding conductor 12, a slit 15 provided between the first radiating conductive plate 13 and the second radiating conductive plate 14, a feeding conductive plate 16 and a first shorting conductive plate 17 that extend substantially orthogonally from an outer edge of the first radiating conductive plate 13 so as not to be opposite to the slit 15, and a second shorting conductive plate 18 that extends substantially orthogonally from an outer edge of the second radiating conductive plate 14 so as not to be opposite to the slit 15. As a result, an inverted F-type antenna whose radiating conductive plate is divided into two pieces can be formed. The first radiating conductive plate 13 and the second radiating conductive plate 14 have shapes similar to each other. The first radiating conductive plate 13 and the second radiating conductive plate 14 are arranged parallel to each other with a line-symmetrical relationship using the slit 15 as an axis of symmetry. A lower end of the feeding conductive plate 16 is connected to a feeding circuit (not shown), and lower ends of the first and second shorting conductive plates 17 and 18 are connected to the grounding conductor 12. In addition, since the slit 15 has a narrow width and extends along longitudinal directions of the first and second radiating conductive plates 13 and 14, the first and second radiating conductive plates 13 and 14 have a relatively strong electromagnetic coupling to each other when a power is supplied to the antenna device 11.

Specifically, when a power is supplied to the antenna device 11, a predetermined high frequency power is supplied to the feeding conductive plate 16 to resonate the first radiating conductive plate 13. Thus, when the first radiating conductive plate 13 resonates, since an induced current flows through the second radiating conductive plate 14 by an electromagnetic coupling between the first and second radiating conductive plates 13 and 14, it is possible to operate the second radiating conductive plate 14 as a radiating element of a parasitic antenna. As a result, a return loss (reflection attenuation quantity) according to a frequency of the antenna device 11 forms a curved line as shown by a solid line in FIG. 3, and two resonance points A and B different from each other are generated. Here, when the electromagnetic coupling intensity between the first and second radiating conductive plates 13 and 14 increases or decreases by changing the width or the length of the slit 15, resonance frequencies corresponding to the resonance points A and B also are changed. Accordingly, when a return loss at any frequency in a range of a resonance frequency f(A) corresponding to the resonance point A to a resonance frequency f(B) corresponding to the resonance point B is not more than −10 dB by suitably adjusting the electromagnetic coupling intensity between the first and second radiating conductive plates 13 and 14, and when it is designed such that a frequency difference between the resonance frequency f(A) and the resonance frequency f(B) increases significantly, it is possible to drastically widen a bandwidth.

For example, when the width of the slit 15 is decreased and the electromagnetic coupling intensity between the first and second radiating conductive plates 13 and 14 is drastically intensified, the resonance frequency f(A) and the resonance frequency f(B) have values substantially equal to each other, and thus the bandwidth thereof becomes narrower. In contrast, when the width of the slit 15 is increased and the electromagnetic coupling intensity between the first and second radiating conductive plates 13 and 14 is weakened drastically, the frequency difference between the resonance frequency f(A) and the resonance frequency f(B) gradually increases and thus the bandwidth thereof becomes wider. However, when the electromagnetic coupling intensity between the first and second radiating conductive plates 13 and 14 is excessively weakened, with regard to signal waves at a predetermined frequency in the range of the resonance frequency f(A) to the frequency frequency f(B), the return loss thereof exceeds −10 dB. As a result, it is extremely difficult to noticeably widen the bandwidth. When the resonance points A and B are set as shown in FIG. 3 by suitably adjusting the electromagnetic coupling intensity between the first and second radiating conductive plates 13 and 14, the frequency range in which the return loss is not more than −10 dB is maximized, consequently the bandwidth can be significantly widened. In addition, a curved line shown by a dot line in FIG. 3 shows the return loss in a conventional example shown in FIG. 5. In the conventional example, since the resonance point thereof is only one, the bandwidth is narrower than that of the present embodiment.

As such, since the antenna device 11 according to the present embodiment can operate the second radiating conductive plate 14 as a radiating element of a parasitic antenna, two resonance points A and B can be set. In addition, since the resonance points A and B which are most useful in widening the bandwidth much are set by suitably adjusting the electromagnetic coupling intensity between the first and second radiating conductive plates 13 and 14 variable according to the width or the length of the slit 15, it is possible to easily ensure a predetermined bandwidth even when making the entire antenna smaller and shorter in size. Thus, according to the antenna device 11 of the present embodiment, it is easy to make the antenna smaller and shorter in size, widen the bandwidth compared to the conventional inverted F-type antenna. In addition, since the antenna device 11 is composed of a sheet metal that is possible to be easily formed by bending a conductive metal plate, it is possible to manufacture the antenna at a low cost.

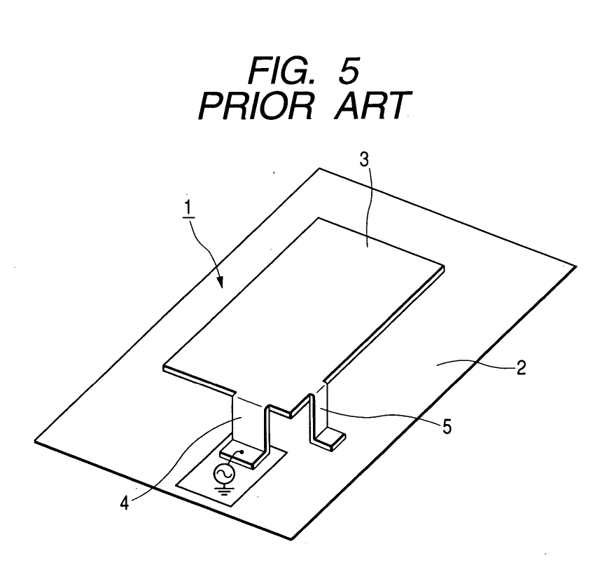

FIG. 4 is a perspective view showing an inverted F-type antenna device according to a second embodiment of the present invention. In FIG. 4, the constituent elements corresponding to those in FIG. 1 are indicated by the same reference numerals.

An antenna device 21 according to the second embodiment is different from the antenna device 11 according to the first embodiment in that crank-shaped notches 19 and 20 are provided respectively in a first radiating conductive plate 13 and a second radiating conductive plate 14. In this manner, since an electric field of each of the first radiating conductive plate 13 and the second radiating conductive plate 14 can be enhanced by providing the notches 19 and 20, it is even easier to make the size of the antenna device 21 smaller compared to the antenna device 11 of the first embodiment. In addition, in the antenna device 21, the second radiating conductive plate 14 adjacent to the first radiating conductive plate 13 with a slit 15 interposed therebetween can be operated as a radiating element of a parasitic antenna. In addition, two resonance points which is used in widening the bandwidth can be set by suitably adjusting an electromagnetic coupling intensity between the first radiating conductive plate 13 and the second radiating conductive plate 14. In addition, in the antenna device 21, the notches 19 and 20 are formed to be line-symmetric to each other using the slit 15 as an axis of symmetry. Accordingly, the first radiating conductive plate 13 and the second radiating conductive plate 14 are arranged parallel to each other with a substantially line-symmetrical relationship using the slit 15 as an axis of symmetry.

1. An antenna device, comprising:
a first radiating conductive plate arranged above a grounding conductor so as to be substantially parallel and opposite to the grounding conductor;
a second radiating conductive plate arranged above the grounding conductor so as to be substantially parallel and opposite to the grounding conductor and adjacent to the first radiating conductive plate with a slit interposed therebetween;
a feeding conductive plate that extends substantially orthogonally from an outer edge of the first radiating conductive plate so as not to be opposite to the slit and is connected to a feeding circuit;
a first shorting conductive plate that extends substantially orthogonally from the outer edge of the first radiating conductive plate so as not to be opposite to the slit and is connected to the grounding conductor; and
a second shorting conductive plate that extends substantially orthogonally from an outer edge of the second radiating conductive plate so as not to be opposite to the slit and is connected to the grounding conductor,
wherein the first radiating conductive plate and the second radiating conductive plate are arranged to be adjacent to each other with a substantially line-symmetrical relationship using the slit as an axis of symmetry and are electromagnetically coupled with each other.

2. The antenna device according to claim 1,
wherein the first radiating conductive plate and the second radiating conductive plate have notches so as to enhance an electric field, and
wherein the notches of the first and second radiating conductive plates are formed to be substantially line-symmetric to each other using the slit as an axis of symmetry.
